(19) United States
(12) Patent Application Publication
(10) Pub. No.: US 2014/0128194 A1
(43) Pub. Date: May 8, 2014

(54) DRIVE UNIT MOUNTED CLOSE TO THE WHEEL FOR A MOTOR VEHICLE

(71) Applicants: Ulrich Mair, Friedrichshafen (DE); Stephan Pollmeyer, Friedrichshafen (DE); Martin Munster, Munchen-Laim (DE)

(72) Inventors: Ulrich Mair, Friedrichshafen (DE); Stephan Pollmeyer, Friedrichshafen (DE); Martin Munster, Munchen-Laim (DE)

(73) Assignee: ZF FRIEDRICHSHAFEN AG, Friedrichshafen (DE)

(21) Appl. No.: 14/233,415

(22) PCT Filed: Jun. 27, 2012
(86) PCT No.: PCT/EP2012/062406

§ 371 Date: Jan. 17, 2014

(30) Foreign Application Priority Data
Jul. 28, 2011 (DE) 10 2011 080 036.0

(51) Int. Cl. B60K 7/00

(52) U.S. Cl. CPC B60K 7/0007
USPC 475/149

(57) ABSTRACT

A drive unit close to the wheel of an electric vehicle having an electric machine with a drive shaft and transmission unit that has at least a first transmission component with an output shaft. The transmission unit interacts with the driveshaft for transferring torque. The drive shaft has, as bearings, two drive shaft bearings and the output shaft has at least one output shaft bearing. At least one of the drive shaft bearings and output shaft bearings is a fixed bearing, and at least an additional drive shaft bearing and the output shaft bearing are loose bearings. The drive and the output shaft bearings are radial bearings. A vehicle can have additional drive units close to the wheel, a vehicle axle can have at least a drive unit close to the wheel and an application of a drive unit close to the wheel.

This application is a National Stage completion of PCT/EP2012/062406 filed Jun. 27, 2012, which claims priority from German patent application serial no. 10 2011 080 036.0 filed Jul. 28, 2011.

### FIELD OF THE INVENTION

The invention concerns a drive unit which is mounted close to the wheel of a motor vehicle, in particular and electric vehicle, comprising an electric machine with a drive shaft, and a transmission unit with at least a first transmission component having an output shaft, whereby the transmission unit interacts with the drive shaft for the transfer of torques. The invention concerns also a vehicle axle with at least a drive unit which is mounted close to the wheel, as well as the use of a drive unit mounted close to the wheel.

### BACKGROUND OF THE INVENTION

Different from the wheel hub motors which are installed directly into the wheel and in contrast to central drives, where several wheels are driven by a centrally positioned drive unit and a respective transmission, drive units which are close to the wheel are known, in particular for electric vehicles. Drive units close to the wheel are generally positioned at the respective ends of a cross profile of a front or rear axle of the electric vehicle to drive the respective wheel.

The single individual drive unit close to the wheel is hereby equipped with an electric machine, which has a drive shaft, and a transmission unit which has at least a transmission component with an output shaft. The drive shaft is connected with a transmission unit, whereby the transmission unit serves to change the rotational speed of the motor into the desired rotational speed of the wheel of the vehicle. Thus and by means of the electric machine, the respective wheel of the electric vehicle is driven.

To provide a bearing for the drive shaft of the electric machine, it is known to provide axial bearings or radial bearings. This enables compact mounting of the drive shaft and the output shaft.

However, a disadvantage is that the drive shaft and the output shaft might tip which leads, in the respective bearings, to the so-called edge support which reduces the lifetime of the bearing. The design of the axial and radial bearings as needle roller bearings leads also to an increased friction due to a so-called boring of the respective roller elements of the needle roller bearings, which causes larger friction losses in the drive unit mounted close to the wheel.

### SUMMARY OF THE INVENTION

It is therefore the task of the present invention to provide a simple and sufficiently, stiff bearing of shafts with a drive unit close to the wheel, which does not significantly increase the mounting space or increase the cost of the manufacturing.

The term radial bearing includes in particular cylindrical roller bearings, groove ball bearings, angular contact ball bearings, and tapered roller bearings.

The invention solves the task with a drive unit which is mounted close to the wheel of a vehicle, in particular in an electric vehicle, comprising an electric machine having a drive shaft and a transmission unit having at least a first transmission component and an output shaft, wherein the transmission unit interacts with the drive shaft to transfer torques in a such way that the drive shaft is supported by means of two drive shaft bearings, and the output shaft is supported by means of at least an output shaft bearing, wherein at least one of the drive shaft bearings and the output shaft bearing is designed as a fixed bearing, and at least an additional drive shaft bearing and an output shaft bearing are designed as loose bearings, and wherein the drive shaft bearings and the output shaft bearing are designed as radial bearings, beside a vehicle which comprises by itself one or several electric motors as drives.

An electric vehicle is also meant to be a vehicle which has, beside one or more electric drive motors, in addition drive motors of a different design, like for instance combustion engines.

The invention also solves the task for a drive unit mounted close to the wheel of a vehicle, in particular an electric vehicle, comprising an electric machine having a drive shaft and a transmission unit having at least a first transmission component with an output shaft whereby the transmission unit interacts with the driveshaft for the transfer of torques in such a way, that the driveshaft is supported by means of two drive shaft bearings and the output shaft by means of at least an output shaft bearing, wherein at least one of the drive shaft bearings and one of the output shaft bearings are designed as adjustable bearings.

The invention also solves the task with a vehicle axle having at least one drive unit close to the wheel in accordance with the description below.

Through the fixed-loose bearing of the driveshaft and the output shaft, and the design of the drive shaft bearings and output shaft bearings as radial bearings, or through the opposite bearings, the stiffness of the bearing of the driveshaft and the output shaft is significantly increased. At the same time, the acoustics of the transmission unit, and therefore the drive unit close to the wheel, are improved because gear wheels, for instance, in the transmission unit have a more reliable meshing performance. Also, the improved bearing makes the shafts and transmission components of the transmission unit less sensitive in regard to tilting, which extends in total the life expectancy of the transmission unit. Finally, efficiency is also optimized because less friction losses occur in the drive unit close to the wheel.

Appropriately, the drive shaft bearings and/or the output shaft bearings are designed as roller bearings, wherein at least one of the loose bearings is designed as a needle roller bearing, wherein at least the other loose bearing or fixed bearing is designed as groove ball bearing or angular contact bearings. Thus, this allows different designs of bearings to be combined with each other which in total further increases the stiffness of the driveshaft and the output shaft, and therefore also of the transmission components in the transmission unit.

Preferably, the output shaft has a second transmission component, in particular a pinion, positioned at it, wherein at least one of the output shaft bearings is positioned between the first and second transmission components. Thus, the efficiency and the life expectancy of the transmission unit, therefore also of the drive unit close to the wheel, can even be improved or increase, respectively. If a spur gear, which interacts with the pinion in a spur gear-pinion configuration, is provided together with a possible stiff bearing, the efficiency of the transmission unit can be further increased. Herein, the pinion at the output shaft is provided, in particular at the end section of the output shaft, with a loose bearing, which is preferably designed as a radial needle roller bearing. The fixed bearing of the output shaft is preferably provided through a radial groove ball bearing.

Appropriately, two output shaft bearings are used, where one of the output shaft bearings is positioned at the side of the first transmission component facing the electric machine. Thus, the output shaft is even more secured against a tilting. Furthermore, a reliable bearing of the output shaft is also possible in the area of the drive shaft.

Preferably, the first transmission component is designed as a planetary transmission and the second transmission component is designed as pinion and positioned at the output shaft of the planetary transmission. The planetary transmission, and the pinion connected with it, enable an extremely cost efficient and a reliable manner to transmit the force of the electric machine to a pinion which, for instance, interacts with a spur gear, which again can drive a wheel of the electric vehicle through a wheel shaft.

Appropriately, the output shaft and the pinion are manufactured as one piece. Thus, sprocket teeth of the pinion can be worked directly into the output shaft and the manufacturing process is therefore simpler.

Advantageously, the output shaft and pinion are linked through an engaging gear for the transfer of torques. Thus, the pinion and the bar, or output shaft respectively, can initially be manufactured separately from each other and then inserted into each other in a simple way for transfer of force. A sophisticated and expensive installation of the pinion and the output shaft, for instance through welding etc., can hereby be omitted.

Appropriately, the opposite bearings of a drive unit close to the wheel are designed as angular contact ball bearings or as needle roller bearings. Thus, the construction space for a drive unit close to the wheel can be reduced, at the same time a sufficient stiffness can be provided for the bearing of the drive shaft and the output shaft.

Advantageously, in a drive unit close to the wheel, a drive shaft bearing is positioned at the inner side of the output shaft. Through the combined bearing of outer and inner radial bearings, the construction space for a drive unit close to the wheel can be reduced even further.

Additional, important characteristics and advantages of the invention can be seen in the drawings, and the related descriptions based on the drawings.

It needs to be understood that the previously mentioned and the following described characteristics cannot only be used in the respective mentioned combination, but also in other combinations or by itself, without exceeding the framework of this present invention.

### BRIEF DESCRIPTION OF THE DRAWINGS

Preferred embodiments of the invention are presented in the drawings and are further explained in the following description, whereby same reference characters relate to the same or similar or functionally similar parts or elements.

In each case show in schematic form

FIG. 1 a cut view presentation of a drive unit close to the wheel in accordance with a first embodiment of the present invention;

FIG. 2 a cut view presentation of a drive unit close to the wheel in accordance with a second embodiment of the present invention;

FIG. 3a-3f different positions of the drive shaft bearings and the output shaft bearings in additional embodiments of drive units close to the wheel, in accordance with the present invention with bearings through groove ball bearings and needle roller bearings;

FIG. 4 a cross section cut through a known drive unit close to the wheel;

FIG. 5a-5f different positions of drive shaft bearings and output shaft bearings in additional embodiments of drive units close to the wheel, in accordance with the present invention with bearings through angular contact bearings or needle roller bearings;

FIG. 6a-6c different positions of drive shaft bearings and output shaft bearings in additional embodiments of the drive unit close to the wheel, in accordance with the present invention with opposite bearings through angular contact bearings.

FIG. 7a-7c different positions of drive shaft bearings and output shaft bearings and additional embodiments of the drive unit close to the wheel, in accordance with the present invention with a loose bearing;

FIG. 8a-8c different positions of drive shaft bearings and output shaft bearings an additional embodiments of the drive unit close to the wheel, in accordance with the present invention with an inner and an outer bearing;

FIG. 9a-9i different positions of drive shaft bearings and output shaft bearings in drive units close to the wheel with needle roller bearings, as well as

FIG. 10 an additional embodiment of the drive unit close to the wheel in accordance with the present invention.

### DETAILED DESCRIPTION OF THE PREFERRED EMBODIMENTS

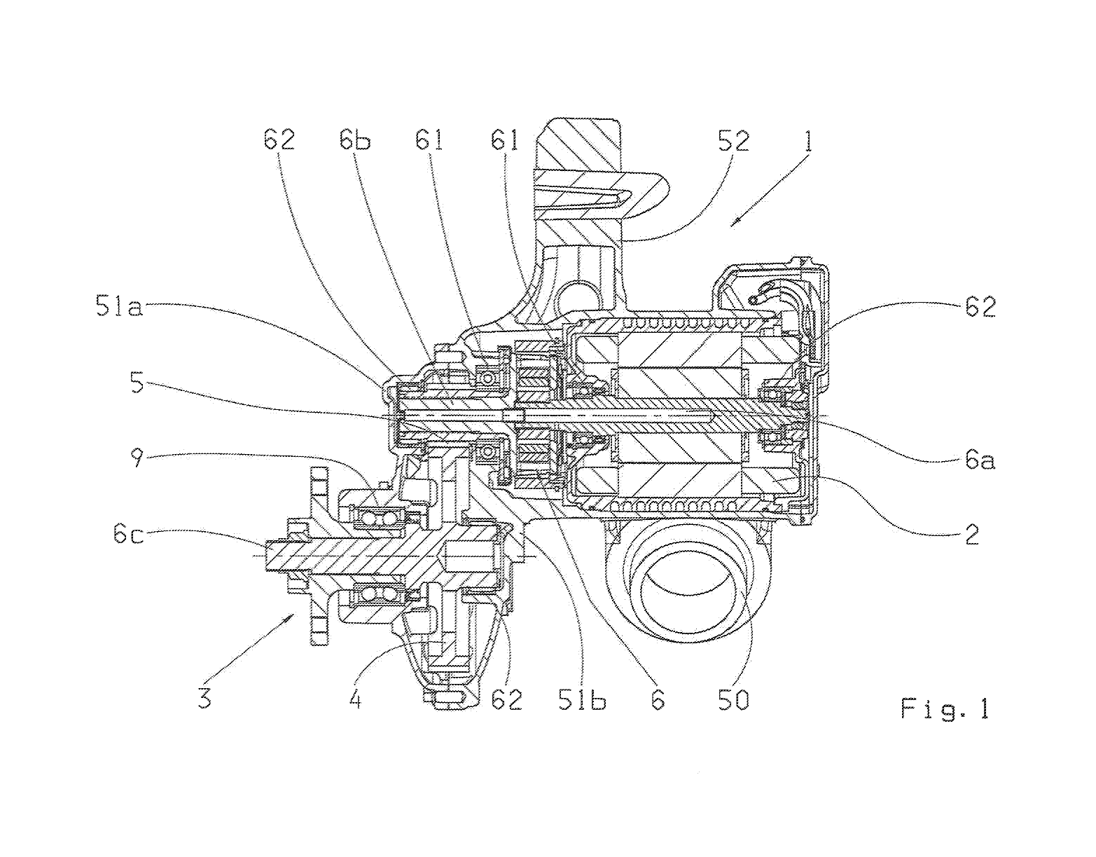

FIG. 1 shows a cut presentation of a drive unit close to the wheel in accordance with the first embodiment of the present invention.

In FIG. 1, the reference character 1 marks a drive unit close to the wheel. The drive unit 1 close to the wheel comprises an electric motor 2 and a transmission unit 3 which are connected with each other for the driving of a wheel. The electric motor 2 has a drive shaft which is designed as sun gear shaft 6a, which interacts with a planetary transmission 6. The planetary transmission 6 has an output shaft designed as a carrier shaft 6b. A pinion 5 is positioned at the carrier shaft 6b, which meshes with a spur gear 4. At the spur gear 4, a wheel shaft 6c is positioned which drives one of the wheels of the electric vehicle and which has a bearing through the wheel bearing 9.

At the outer side of the electric motor 2, a spring seat 50 is positioned which serves to accommodate a spring. The spring is here supported at the body of the electric vehicle. Altogether, the drive unit 1 close to the wheel is positioned at a trailing arm 52 of a twist beam axle (not shown).

The sun gear shaft 6a and the carrier shaft 6b of the transmission unit 1 have a bearing in FIG. 1 as follows: the sun gear shaft 6a has a bearing at the side which faces a way from the electric motor 2 of the transmission unit 1 by means of a loose bearing 62, in the area of between the planetary transmission 6 and the electric motor 2 by means of a fixed bearing 61. The carrier shaft 6b has a bearing between the planetary transmission 6 and the pinion 5 by means of the fixed bearing 61. The fixed bearing is preferably designed as a radial groove ball bearing and is positioned in the housing of the trailing arm 51b. At the side of the pinion 5 which is facing away from the planetary transmission 6, a carrier shaft 6b is provided with a floating bearing (loose bearing 62) which is preferably designed as a radial needle roller bearing, it is preferably positioned in an housing 51a at the wheel side of the drive unit 1 close to the wheel.

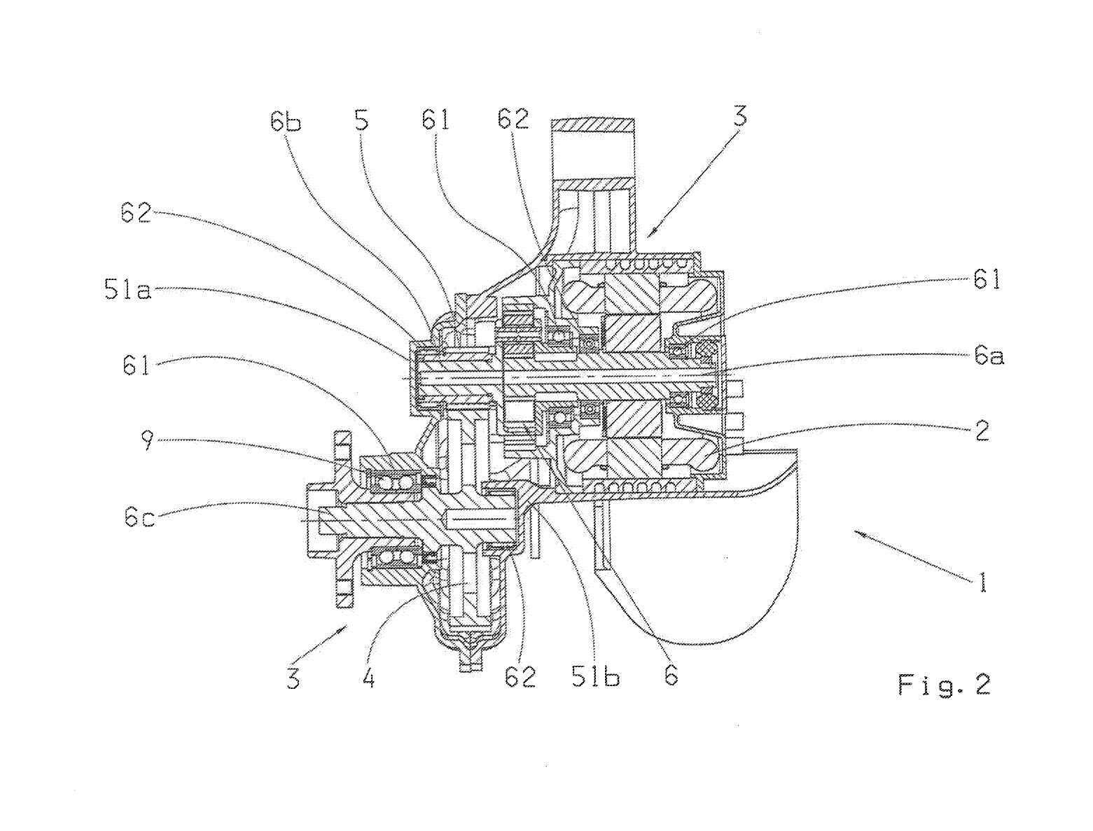

FIG. 2 shows a cut view presentation of a drive unit close to the wheel in accordance with a second embodiment of the present invention.

FIG. 2 shows mainly a drive unit 1 close to the wheel in accordance with FIG. 1. In contrast to FIG. 1, the fixed bearing 61 and the loose bearing 62 of the sun gear shaft 6a have been swapped, meaning that the sun gear shaft 6a has a bearing through the fixed bearing 61 at the side of the electric motor 2 which is facing away from the transmission unit 3, wherein the sun gear shaft 6a has as a bearing, a loose bearing 62 in the area between the electric motor 2 and the planetary transmission 6. It is therefore possible to reduce the axial extension of the drive shafts, in particular the sun gear shaft 6a and the carrier shaft 6b when, for instance, the fixed bearing 61 for the carrier shaft 6b can be a positioned under an end winding of the electric motor 2.

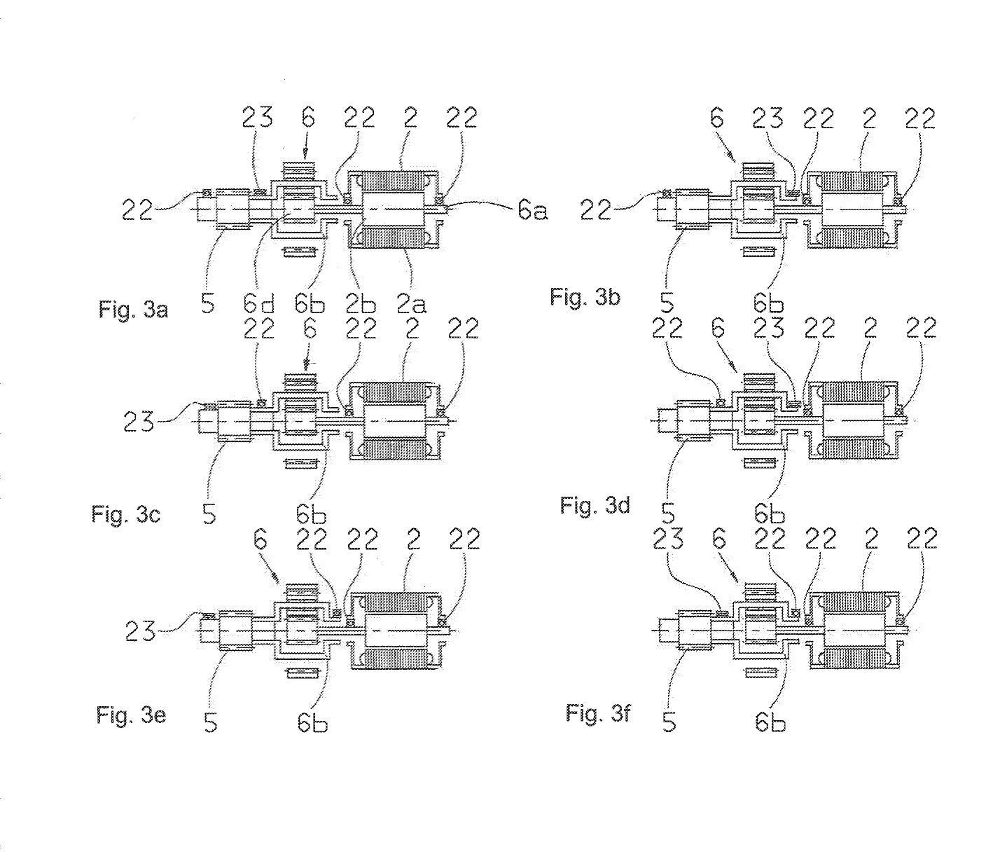

FIG. 3a-3f show different positions of drive shaft bearings and output shaft bearings in additional embodiments of drive units close to the wheel in accordance with the invention, using bearings such as groove ball bearings and needle roller bearings.

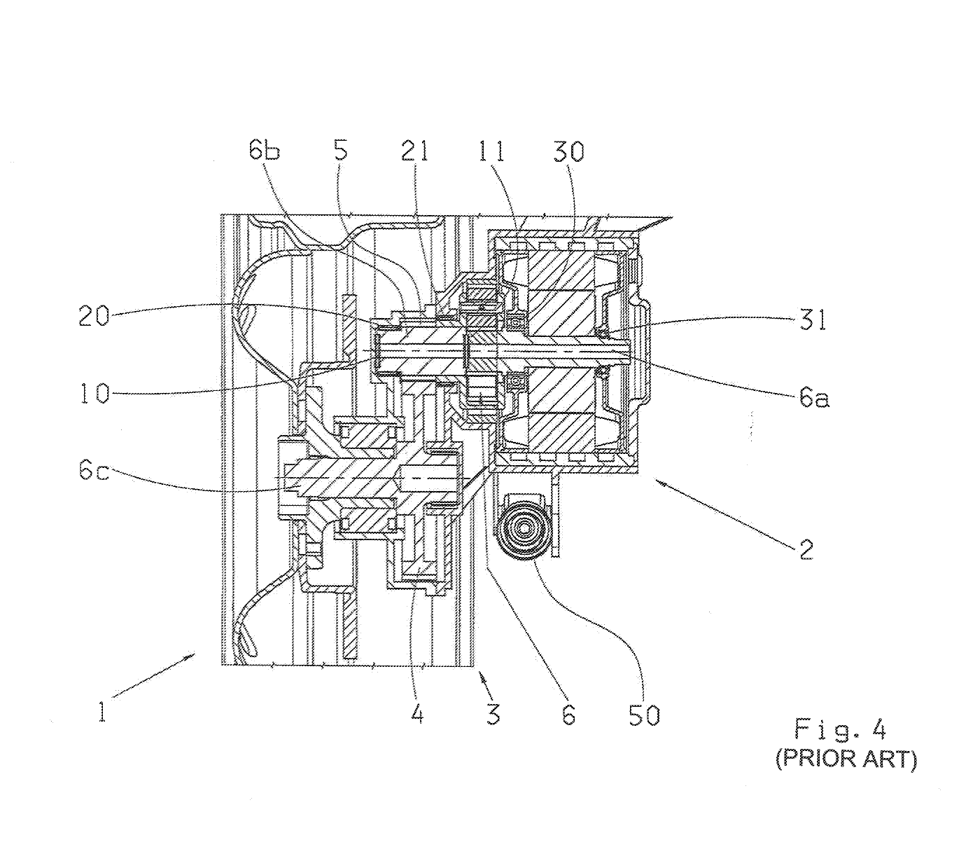

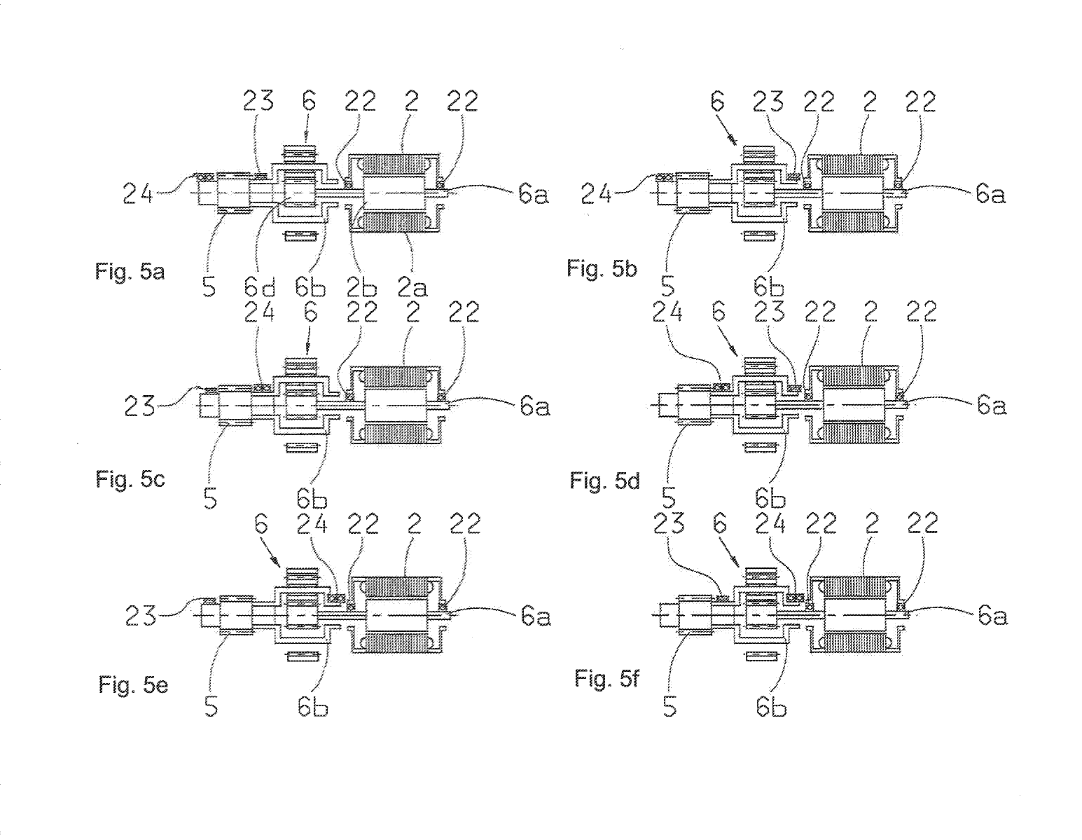

In FIG. 3a-3f, as well as also the additional drawings in FIG. 5a-5f, 6a-6c, 7a-7c, 8a-8c, and 9a-9i, the following configurations are identical from left to right: an electric motor 2 is positioned on the right side which is connected with a sun gear shaft 6a as the drive axle. The sun gear shaft 6a has on the left side a sun gear 6d, which meshes with a planetary transmission 6. The planetary transmission 6 has, extending to the left, a carrier shaft 6b as an output shaft. At the output shaft 6b, a pinion 5 is positioned. Altogether, and from the right to the left, the electric motor 2 and the planetary transmission 6 are positioned, and on the left side is the pinion 5, wherein the electric motor 2, comprising a stator 2a and a rotor 2b, are connected through the sun gear shaft 6a with the planetary transmission 6, and the planetary transmission 6 through the carrier shaft 6b with a pinion 5. The electric motor 2 has again a respective housing in which the sun gear shaft 6a is supported at the side of the planetary transmission 6 on one hand, and at the opposite side through bearings at the housing of the electric motor 2. Therefore, the term “left bearing” and “right bearing” of the electric motor identifies the bearing which is neighboring the planetary transmission 6, or the bearing which is positioned at the opposite side of the planetary transmission 6 for the sun gear shaft 6a at the electric motor 2. The same applies accordingly also for the bearings which are positioned at the carrier shaft 6b. Herein, the planetary transmission 6 is again the reference in regard to the word “left” with reference for a bearing which is positioned between the planetary transmission 6 and a pinion 5, and in regard to the word “right” bearing which is positioned at the carrier shaft 6b at the side which faces the planetary transmission 6 of the electric motor 2.

In the following, the individual configuration for the drawing FIG. 3a-3f are described from left to right with the different bearings in different positions: the sun gear shaft 6a has the bearing in FIG. 3a at the left and at the right side of the electric motor 2 through a groove ball bearing 22 at the housing of the electric motor 2. The carrier shaft 6b has a bearing on the left side of the planetary transmission 6 which is a needle roller bearing 23. On the left side of the pinion 5 is again provided with a groove ball bearing 22.

In FIG. 3b, the needle roller bearing 23 is positioned, instead of on the left side of the planetary transmission 6, now on the right side of the planetary transmission 6 at the carrier shaft 6b, meaning between the planetary transmission 6 and the electric motor 2.

In FIG. 3c, the groove ball bearing 22 and the needle roller bearing 23 as in FIG. 3a have been swapped, but the overall configuration remains the same.

In FIG. 3d, and in contrast to FIG. 3b, the groove ball bearing 22 of the carrier shaft 6b is not positioned on the left side of the pinion 5, but on the left side of the planetary transmission 6, meaning between the pinion 5 and the planetary transmission 6.

FIG. 3e shows the swapped positions of the groove ball bearing 22 and the needle roller bearing 23 at the carrier shaft 6b, in reference to the configuration as in FIG. 3b.

In FIG. 3f, the positions of the groove ball bearing 22 and the needle roller bearing 23 for the carrier shaft 6b have been swapped, in reference to the configuration shown in FIG. 3d.

FIG. 4 shows a cross-section through a known drive unit close to the wheel.

FIG. 4 shows a drive unit 1 close to the wheel which comprises an electric motor 2 and a transmission unit 3. The electric motor 2 has a sun gear shaft 6a as a drive shaft which is connected with a planetary transmission 6. The planetary transmission 6 has as an output shaft, a carrier shaft 6b at which a pinion 5 is positioned. The pinion 5 by itself is in an operational connection with a spur gear 4, and the spur gear 4 is in an operational connection with a wheel shaft 6c so as to drive a wheel. The sun gear shaft 6a has radial bearings in an X-configuration 30, 31 at the electric motor 2 on the side which faces and also facing a way from the planetary transmission 6. The sun gear shaft 6a is supported in the planetary transmission 6 by an axial needle roller bearing 11. The carrier shaft 6b is supported on the side of the pinion 5, which is facing away from the planetary transmission 6, by an axial needle roller bearing 10. Also, on the side of the pinion 5 which is facing away from the planetary transmission 6 is a radial bearing 20 positioned for the carrier shaft 6b. The carrier shaft 6b is also connected, via a radial bearing 21 which is positioned between the pinion 5 and the planetary transmission 6, to the carrier shaft 6b. The drive unit 1 close to the wheel which is shown in FIG. 4 has the disadvantages described in the introduction section of the specification.

FIG. 5a-5f shows different positions of drive shaft bearings and output shaft bearings in additional embodiments of drive units close to a wheel, in accordance with the present invention, through angular contact ball bearings and needle roller bearings.

FIG. 5a-5f references again the general descriptions for the positioning in regard to the electric motor 2, the planetary transmission 6, and the pinion 5, as mentioned previously in the description to FIG. 3a-3f.

The configurations shown in FIG. 5a-5f correspond in each case with the configuration in FIG. 3a-3f, however, FIG. 5a-5f show now, instead of the provided groove ball bearings 22 in FIG. 3a-3f, in each case two pairs of angular contact ball bearings as fixed bearings 24.

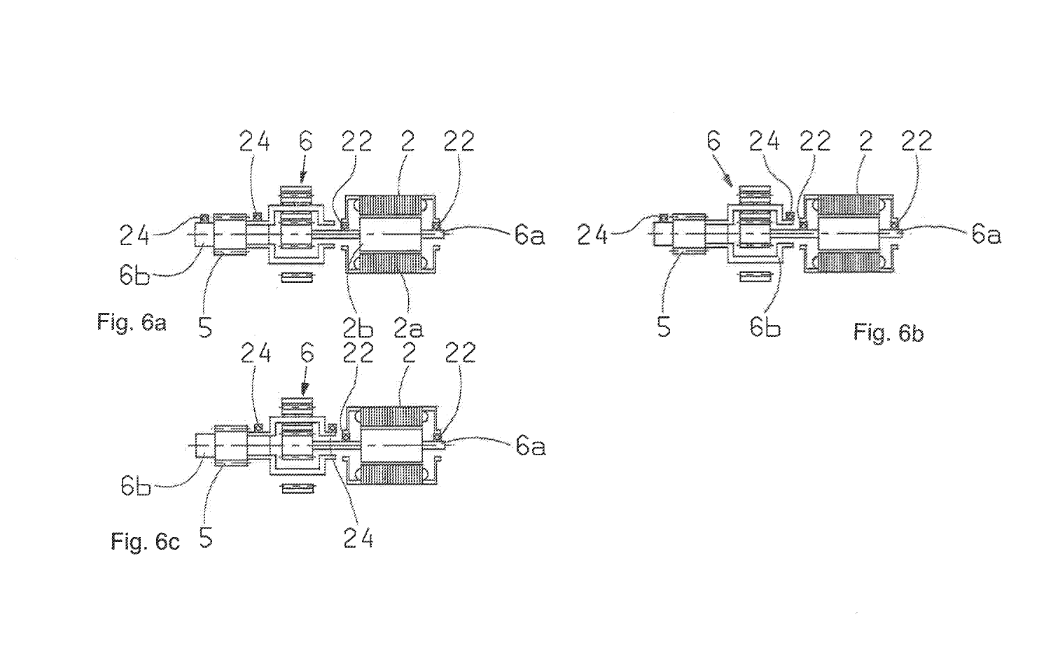

FIG. 6a-6c show different positions of drive shaft bearings and output shaft bearings in additional embodiments of the drive unit close to the wheel, in accordance with the present invention with opposite bearings through angular contact ball bearings.

The construction shown in FIG. 6a corresponds to the one shown in FIG. 3a, FIG. 6b to FIG. 3b, and FIG. 6c to FIG. 3d. Different from FIGS. 3a, 3b, and 3d is the positioning of a simple angular contact ball bearing 24 instead of the respective groove ball bearing 22 and the needle roller bearing 23. The angular contact ball bearings 24, in particular for the carrier shaft 6b, are herein configured with each other as adjusted bearings, for instance in an X-configuration or O-configuration.

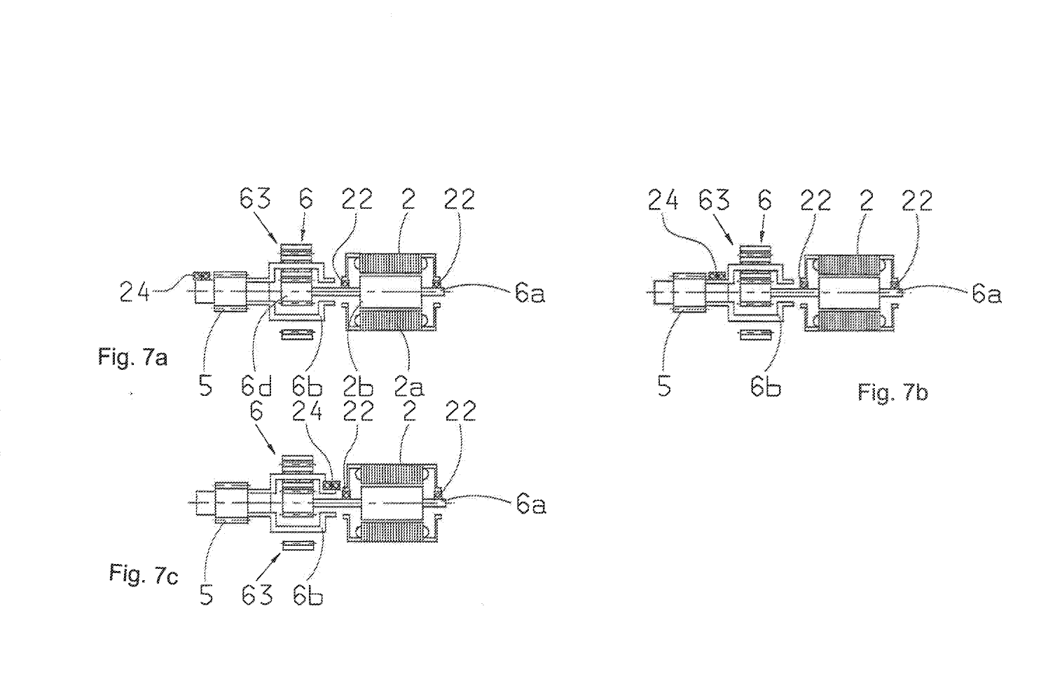

FIG. 7a-7c show different positions of drive shaft bearings and output shaft bairings in additional embodiments of the drive unit close to the wheel, in accordance with the present invention, with cantilever bearings.

The positioning of the respective bearings in the drive unit close to the wheel, in accordance with FIG. 7a-7c, corresponds mainly to the embodiments in FIG. 5a, 5d, and 5c. Different from FIG. 5a, 5d, 5f is that the respective needle roller bearing 23 is replaced with a cantilever bearing 63 by the planetary transmission 6.

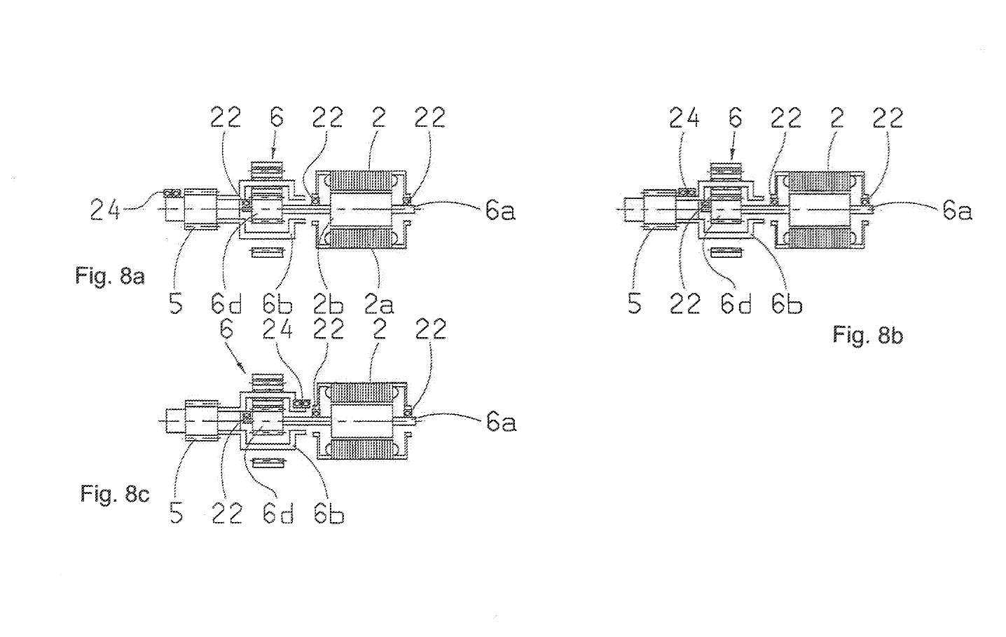

FIG. 8a-8c show different positions of drive shaft bearings and output shaft bearings in additional embodiments of the drive unit close to the wheel, in accordance with the present invention, with inner and outer bearings.

FIG. 8a-8c essentially show embodiments of FIG. 7a-7c. In contrast to FIG. 7a-7c, where a cantilever bearing 63 is provided by the planetary transmission 6, the sun gear shaft 6a in FIG. 8a-8c is supported in the planetary transmission 6 by a groove ball bearing 22 on the carrier shaft 6b. The groove ball bearing 22 is, in each case, positioned on the side of the planetary transmission 6 which faces away from the electric motor 2, meaning on the left side of the sun gear 6d of the sun gear shaft 6a.

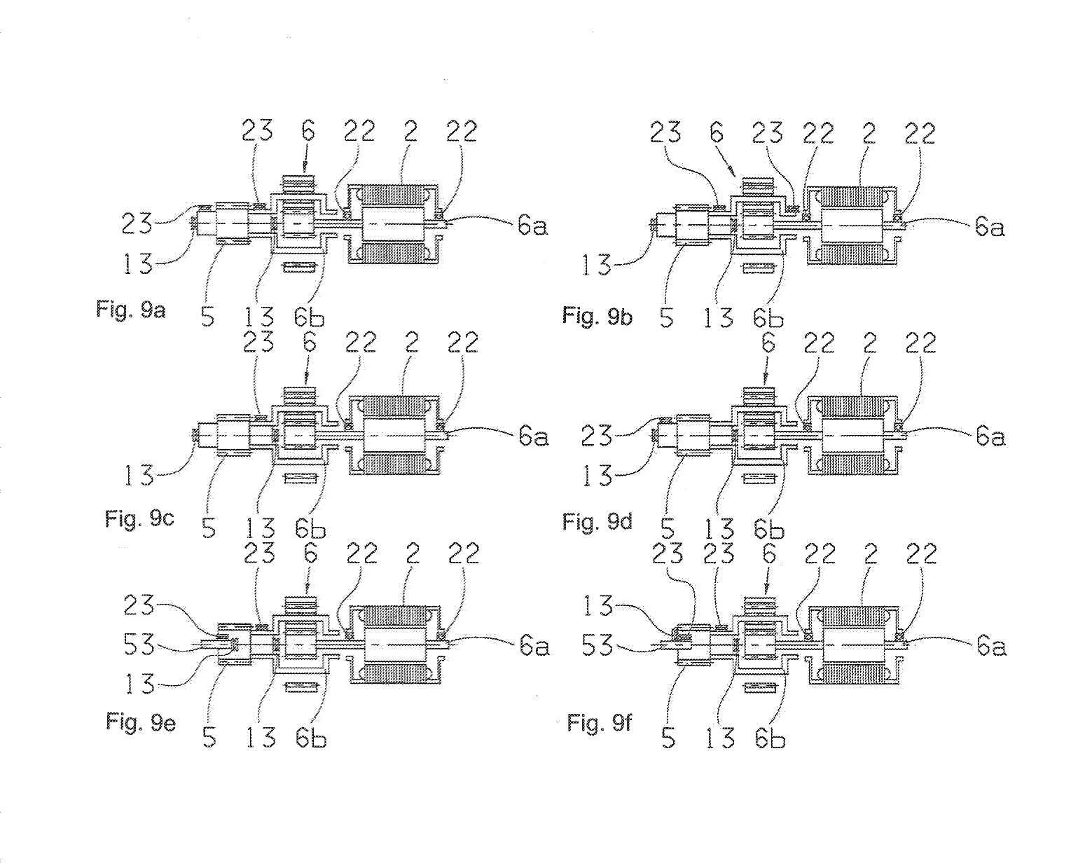

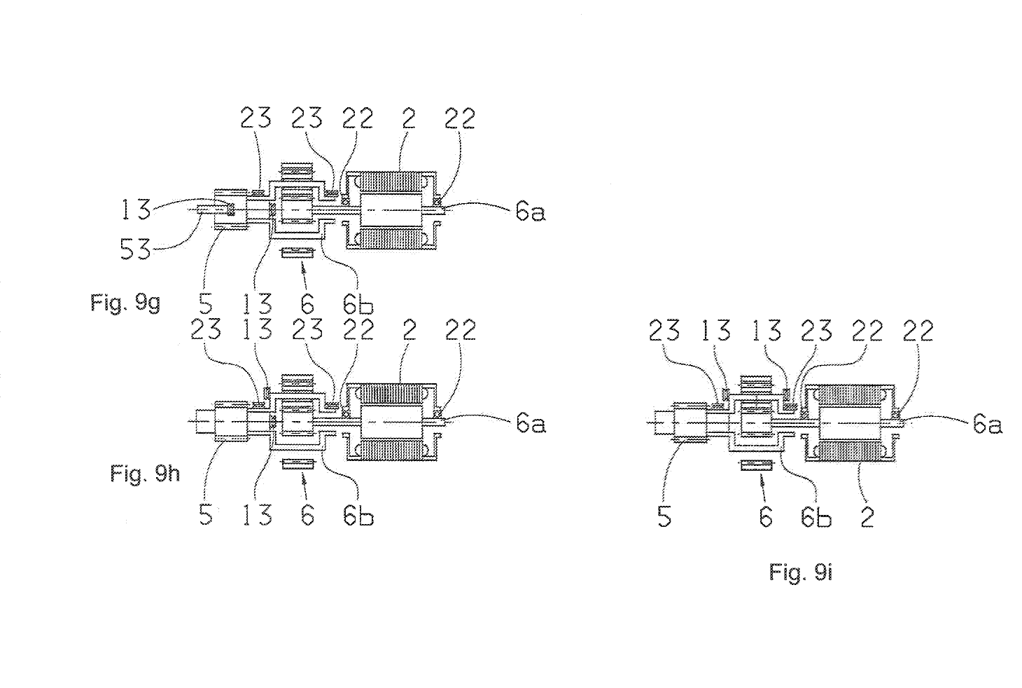

FIG. 9a-9e show different positions of drive shaft bearings and output shaft bearings in drive units close to the wheel with needle roller bearings.

FIG. 9a is a schematic presentation in accordance with the configuration of the drive unit 1 close to the wheel of FIG. 4, with two axial bearings 13, each on the left side of the carrier shaft 6b and the left side of the sun gear shaft 6a, and with two radial bearings, wherein in each case one of them is positioned at the outer side of the carrier shaft 6b, left of the pinion 5, and on the other side of the carrier shaft 6b, between the planetary transmission 6 and the pinion 5.

FIG. 9b essentially shows the same configuration of the drive unit 1 close to the wheel in accordance with FIG. 9a. In contrast to FIG. 9a, the needle roller bearing 23 is not positioned on the left side of the pinion 5 at the carrier shaft 6b, but instead between the planetary transmission 6 and the electric motor 2.

FIG. 9c essentially shows the same configuration of the drive unit close to the wheel in accordance with FIG. 9a. In contrast to FIG. 9a, there is no needle roller bearing 23 positioned on the left side of the pinion 5 as a radial bearing on the radial outer side of the carrier shaft 6b, but instead the planetary transmission constitutes the second bearing of the carrier shaft.

FIG. 9d essentially shows the same configuration of the drive unit close to the wheel in accordance with FIG. 9a. In contrast to FIG. 9a, there is now no needle roller bearing 23 positioned at the radial outer side of the carrier shaft 6b between the pinion 5 and the planetary transmission 6. Instead, the planetary transmission constitutes the second bearing of the carrier shaft.

FIG. 9e essentially shows the same configuration of a drive unit close to the wheel in accordance with FIG. 9a. In contrast to FIG. 9a, in which an axial needle bearing 13 and a needle bearing 23 are disposed on the radially outer side of the carrier shaft 6b to the left of the pinion 5, now within the spider shaft 6b as shown in FIG. 9e is an axial needle bearing 13 on a stud 53 that extends parallel to the carrier shaft 6b and extends into it. At the radial outer side of the stud 53 in the carrier shaft 6b, there is also the needle roller bearing 23 positioned, such that the carrier shaft 6b has a rotatable bearing.

FIG. 9f essentially shows the same drive unit close to the wheel in accordance with FIG. 9e. In contrast to FIG. 9e, the axial needle roller bearing 13 is not positioned on the inside of the pinion 5 or the carrier shaft 6b, respectively, but at the radial outer side of the stud 53 on the left facing side of the pinion 5.

FIG. 9g essentially shows the same drive unit close to the wheel in accordance with FIG. 9e. In contrast to FIG. 9e, the needle roller bearing 23 positioned at the stud 53, is now positioned at the carrier shaft 6b in the area between the planetary transmission 6 and the electric motor 2.

FIG. 9h essentially shows the same drive unit close to the wheel in accordance with FIG. 9b. In contrast to FIG. 9b, instead of the needle roller bearing 13 being positioned at the left side of the pinion 5, the needle roller bearing 13 is now positioned between the pinion 5 and the planetary transmission 6 at a bar of the carrier shaft 6b, perpendicular to the carrier shaft 6b.

FIG. 9i essentially shows the same drive unit close to the wheel in accordance with FIG. 9h. In contrast to FIG. 9h, the inner axial needle roller bearing 13 for the sun gear shaft 6a is now positioned at the carrier shaft 6b of the planetary transmission 6 in the area of the bar of the carrier shaft 6b, perpendicular to the carrier shaft 6b, between the planetary transmission 6 and the electric motor 2.

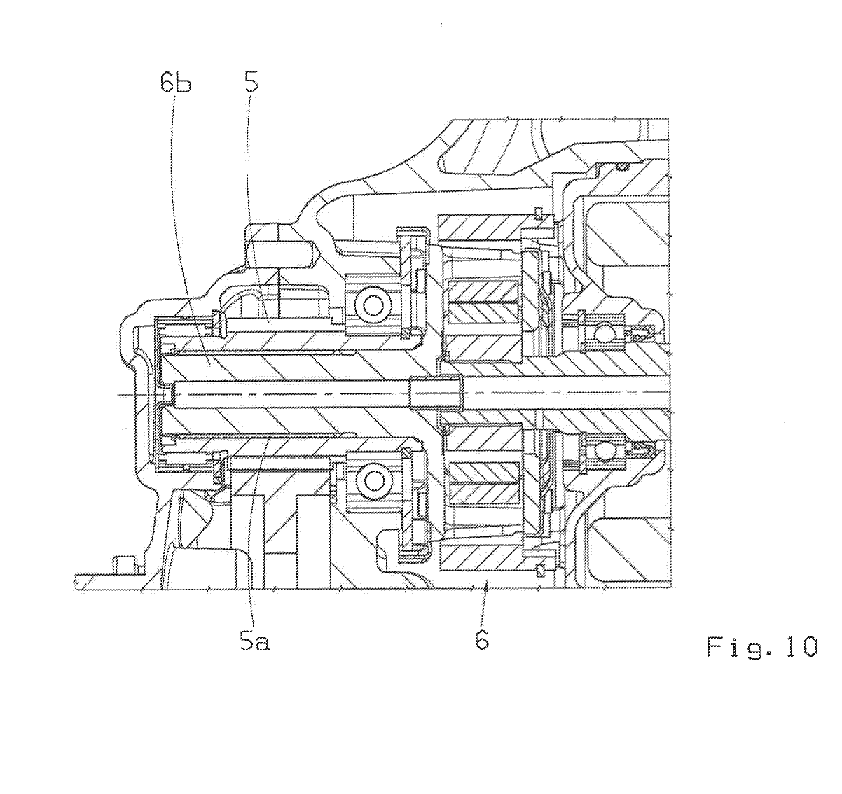

FIG. 10 shows an additional embodiment of the drive unit close to the wheel in accordance with the present invention.

FIG. 10 shows a detailed view of the carrier shaft 6b in the area of the planetary transmission 6 and the pinion 5. The pinion 5 has at its radial inner side, and the carrier shaft 6b has at its radial outer side, neighboring the pinion 5, a drive gearing 5a such that the carrier shaft 6b can transfer torque by means of the drive gearing 5a to the pinion 5.

In summary, the invention has, among other things, the advantage that it provides a simple and at the same time a stiff bearing for the driveshaft and the output shaft of a drive unit close to the wheel. Through the increased stiffness, the gears in the transmission unit can mesh with each other more exactly and thus noise is hereby omitted. At the same time, unnecessary friction is omitted which improves the efficiency of the drive unit close to the wheel. The invention also enables that left and ride drive units close to the wheel can be positioned at an axle with identical gears, in particular with the same helix angles: axial and radial forces are guided through the fixed bearings into the respective housing of the transmission unit or of the electric motor. It allows lower manufacturing costs for the drive unit close to the wheel, because it results in higher quantities for the gear wheels and therefore a low cost.

Although the present invention has been described above based on preferred embodiments, the invention is not limited to it, can also be modified in various ways.

### REFERENCE CHARACTERS

1 Drive Unit near the wheel
2 Electric Motor
2a Stator
2b Rotor
3 Transmission Unit
4 Spur Gear
5 Pinion
5a Drive Gearing
6 Planetary Transmission
6a Sun Gear Shaft
6b Carrier Shaft
6c Wheel Shaft
6d Sun Gear
9 Wheel Bearing
10 Axial Needle Roller Bearing
11 Axial Needle Roller Bearing
12 Groove Ball Bearing
13 Needle Roller Bearing
20 Radial Bearing
21 Radial Bearing
22 Groove Ball Bearing
23 Needle Roller Bearing
24 Angular Contact Ball Bearing
30 Radial Ball Bearing X-Configuration
31 Radial Ball Bearing X-Configuration
50 Spring Seat
51a Housing at Wheel
51b Housing at Trailing Arm
52 Trailing Arm
61 Fixed Bearing
62 Loose bearing
63 Cantilever

1-14. (canceled)

15. A drive unit (1) close to a wheel or a motor vehicle, the drive unit comprising:
an electric machine (2) with a drive shaft (6a),
a transmission unit (3) with at least a first transmission component (6) having an output shaft (6b), and the transmission unit (3) interacting with the drive shaft (6b) for transferring torque,
the drive shaft (6a) being supported by two drive shaft bearings (22, 23, 24),
the output shaft (6b) being supported by at least one output shaft bearing (22, 23, 24),
at least one of the drive shaft bearings (22, 23, 24) and the output shaft bearings (22, 23, 24) being designed as a fixed bearing (61),
at least an additional one of the drive shaft bearings (22, 23, 24) and the output shaft bearings (22, 23, 24) being a loose bearing (62), and
the drive shaft bearings (22, 23, 24) and the output shaft bearings (22, 23, 24) being designed as radial bearings (20, 21).

16. The drive unit (1) close to the wheel according to claim 15, wherein at least one of the drive shaft bearings (22, 23) and the output shaft bearings (22, 23) are designed as roller bearings,
at least one of the loose bearings (61, 62) is designed as a needle roller bearing (23), and
either the loose bearing (62) or the fixed bearing (61) is designed as either a groove ball bearing (22) or an angular contact bearing (24).

17. The drive unit (1) close to the wheel according to claim 15, wherein the output shaft (6b) comprises a second transmission component (5), and
at least one of the output shaft bearings (22, 23, 24) is positioned between the first and the second transmission components (5, 6).

18. The drive unit (1) close to the wheel according to claim 17, wherein at least one of the output shaft bearings (22, 23, 24) is positioned adjacent the second transmission component (5), on a side of the second transmission component (5) facing away from the first transmission component (6).

19. The drive unit (1) close to the wheel according to claim 15, wherein the drive unit comprises two output shaft bearings (22, 23, 24) and one of the output shaft bearings (22, 23, 24) is designed as a cantilever bearing.

20. The drive unit (1) close to the wheel according to claim 15, wherein the drive unit comprises two output shaft bearings (22, 23, 24) and one of the two output shaft bearings (22, 23, 24) is positioned adjacent the first transmission component (6), on a side of the first transmission component that faces the electric machine (2).

21. The drive unit (1) close to the wheel according to claim 17, wherein the first transmission component (6) is designed as a planetary transmission and the second transmission component (5) is designed as a pinion and positioned adjacent the output shaft (6b) of the planetary transmission (6).

22. The drive unit (1) close to the wheel according to claim 15, wherein the output shaft (6b) and the pinion (5) are manufactured as one piece.

23. The drive unit (1) close to the wheel according to claim 21, wherein the output shaft (6b) and the pinion (5) are connected, via a drive gearing (5a), so as to transfer torque.

24. A drive unit (1) close to the wheel for an electric vehicle, the drive unit comprising:
an electric machine (2) with a drive shaft (6a),
a transmission unit (3) with at least a first transmission component (6) having an output shaft (6b), and the transmission unit (3) interacting with the drive shaft (6a) for transferring torque,
the drive shaft (6a) being supported by at least one drive shaft bearing (22, 23, 24),
the output shaft (6b) being supported by at least one output shaft bearing (22, 23, 24), and
at least one of the drive shaft bearings (22, 23, 24) and one of the output shaft bearings (22, 23, 24) being designed as adjusting bearings.

25. The drive unit (1) close to the wheel according to claim 24, wherein the adjusting bearings are designed as at least one of tapered roller bearings, angular contact bearings (24) and needle roller bearings (23).

26. The drive unit (1) close to the wheel according to claim 15, wherein a drive shaft bearing (22, 23, 24) is positioned adjacent an inner side of the output shaft (6b).

27. The drive unit (1) close to the wheel according to claim 24, wherein a drive shaft bearing (22, 23, 24) is positioned adjacent an inner side of the output shaft (6b).

28. The drive unit (1) close to the wheel according to claim 15, further comprising that the drive unit is applied to drive the wheel of an electric vehicle.

29. A vehicle axle in combination with a drive unit (1) close to the wheel of a vehicle, the drive unit comprising:
an electric machine (2) with a drive shaft (6a),
a transmission unit (3) with at least a first transmission component (6) having an output shaft (6b), and the transmission unit (3) interacting with the drive shaft (6b) for transferring torque,
the drive shaft (6a) being supported by two drive shaft bearings (22, 23, 24) and the output shaft (6b) being supported by at least one output shaft bearing (22, 23, 24),
at least one of the drive shaft bearings (22, 23, 24) and the output shaft bearings (22, 23, 24) being designed as a fixed bearing (61) and at least an additional one of the drive shaft bearings (22, 23, 24) and the output shaft bearings (22, 23, 24) being a loose bearing (62), and
the drive shaft bearings (22, 23, 24) and the output shaft bearings (22, 23, 24) being designed as radial bearings (20, 21).
